(19) United States
(12) Patent Application Publication
(10) Pub. No.: US 2026/0292580 A1
(43) Pub. Date: Sep. 24, 2026

(54) METHOD AND APPARATUS FOR MULTI-BITS SCHEDULING REQUEST TRANSMISSION IN MOBILE COMMUNICATIONS

(71) Applicant: MEDIATEK SINGAPORE PTE. LTD., Singapore (SG)

(72) Inventors: Abdulhamed Khaled E WARAIET, Cambridge (GB); Sumaila Anning MAHAMA, Cambridge (GB); Mohammed S Aleabe AL-IMARI, Cambridge (GB)

(73) Assignee: MEDIATEK SINGAPORE PTE. LTD., Singapore (SG)

(21) Appl. No.: 19/475,727

(22) PCT Filed: Sep. 19, 2024
(86) PCT No.: PCT/CN2024/119636

§ 371 Date: Oct. 15, 2025

Related U.S. Application Data
(60) Provisional application No. 63/596,328, filed on Nov. 6, 2023.

(51) Int. Cl. H04W 28/02; H04W 72/21; H04W 72/23

(52) U.S. Cl. CPC H04W 28/0205; H04W 28/0278; H04W 72/21; H04W 72/23

(57) ABSTRACT

Various solutions for multi-bits scheduling request (SR) transmission with respect to an apparatus in mobile communications are described. The apparatus may receive an SR configuration from a network node. The apparatus may transmit an SR including a plurality of bits to the network node according to the SR configuration. The plurality of bits may indicate pending data and a size of the pending data.

### CROSS REFERENCE TO RELATED PATENT APPLICATION(S)

The present disclosure is part of a non-provisional application claiming the priority benefit of U.S. Patent Application No. 63/596,328, filed 6 Nov. 2023, the content of which herein being incorporated by reference in its entirety.

### TECHNICAL FIELD

The present disclosure is generally related to mobile communications and, more particularly, to multi-bits scheduling request transmission with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, scheduling request (SR) enables user equipment (UE) to request uplink (UL) grant from network for data transmission. More specifically, the SR is a special physical layer message from the UE asking the network for an UL grant to transmit physical uplink shared channel (PUSCH), and the SR has only 1 bit for indicating that the UE has pending data to transmit and requests the necessary network resources.

In some scenarios, the SR is dynamically triggered by the UE when the UE has data to transmit but lacks an UL grant from the network, which may suffer significant scheduling latencies. For example, the scheduling latencies may be impacted by the frequency of SR occasions (i.e., SR periodicity), the frequency of physical downlink control channel (PDCCH) occasions (i.e., PDCCH periodicity), the UL and downlink (DL) processing delays, etc.

However, the scheduling latencies depend on various factors, such as network conditions, processing capabilities and scheduling algorithms, and the scheduling latencies of SR are critical parameters that influence the performance and responsiveness of the overall network. Accordingly, how to reduce the scheduling latencies of SR becomes an important issue in the newly developed wireless communication network. Therefore, there is a need to provide proper schemes to reduce the scheduling latencies of SR.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to multi-bits scheduling request (SR) transmission with respect to apparatus in mobile communications.

In one aspect, a method may involve an apparatus receiving an SR configuration from a network node. The method may also involve the apparatus transmitting an SR including a plurality of bits to the network node according to the SR configuration. The plurality of bits may indicate pending data and a size of the pending data.

In one aspect, a method may involve an apparatus transmitting an SR configuration to a UE. The method may also involve the apparatus receiving an SR including a plurality of bits from the UE according to the SR configuration. The plurality of bits may indicate pending data and a size of the pending data.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, via the transceiver, an SR configuration from a network node. The processor may also perform operations comprising transmitting an SR including a plurality of bits to the network node according to the SR configuration. The plurality of bits may indicate pending data and a size of the pending data.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to multi-bits scheduling request (SR) transmission with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may determine an SR configuration, and transmit the SR configuration to a user equipment (UE). The SR configuration may indicate to the UE to transmit SR with multi-bit while the bits may be used to indicate data needed to be transmitted. After receiving the SR configuration, the UE may apply the SR configuration. When there is data arrival in buffer of the UE (e.g., network packet arrival in buffer of the UE), the UE may transmit an SR including a plurality of bits to the network node. The plurality of bits may indicate: (1) pending data in the buffer of the UE; and (2) a size of the pending data. The network may receive the SR including the plurality of bits and obtain information of the pending data and the size of the pending data based on the SR including the plurality of bits.

Accordingly, the network node may determine an uplink (UL) grant for the UE directly based on the SR, which includes the plurality of bits, without additional procedure of receiving message associated with the pending data and the size of the pending data so that the scheduling latencies (e.g., latencies caused by network message transmission delay, UL and downlink (DL) processing delay, etc.) may be significantly reduced.

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network may determine an SR configuration. The SR configuration may indicate to the UE to transmit SR with multi-bit while the bits may be used to indicate data needed to be transmitted. The network node may transmit the SR configuration to the UE. After receiving the SR configuration, the UE may apply the SR configuration. Accordingly, when the UE needs to request UL grant from the network for data transmission, the UE may transmit an SR including a plurality of bits to the network node according to the SR configuration.

The plurality of bits may indicate: (1) pending data; and (2) a size of the pending data. In other words, the plurality of bits included in the SR may be used to signal: (1) presence of network packet arrival in a buffer of the UE; and (2) size of network packet arrival in the buffer of the UE. After receiving the SR, the network node may obtain information of the pending data and the size of the pending data based on the SR including the plurality of bits, and then may transmit an UL grant to the UE for data transmission.

In some implementations, the SR configuration may include a specific parameter indicating to the UE to transmit the SR including the plurality of bits. In some cases, when the specific parameter is included in the SR configuration, the UE may be configured to transmit the SR including the plurality of bits. In some cases, when the specific parameter is not included in the SR configuration, the UE may be configured to transmit an SR with single bit which may cause significant scheduling latencies during later procedure.

In some implementations, the SR including the plurality of bits may be introduced for various network scenarios. In some cases, the SR including the plurality of bits may be used for a latency critical application. In other words, the SR including the plurality of bits may be used for an application that is more latency sensitive (e.g., XR application). In some cases, the SR including the plurality of bits may be used for reporting the pending data and the size of the pending data associated with one or more logical channels. In some cases, the UE may transmit single SR including the plurality of bits for the pending data of all the logical channels. In some cases, the UE may transmit single SR including the plurality of bits for the pending data of one logical channel. However, it is not intended to limit the network scenarios to which the SR including the plurality of bits is applied.

In some implementations, the network may transmit an SR table to the UE. The SR table may include a plurality of buffer state items. The plurality of bits may indicate the pending data and the size of the pending data based on at least one of the plurality of buffer state items.

Specifically, the SR table may be a network side predefined table and be transmitted in a higher layer signaling (e.g., radio resource control (RRC) configuration). In the SR table, each of the plurality of buffer state items may include an index and a buffer size. The buffer sizes may increment with a same step size (i.e., the buffe sizes of the buffer state items increase linearly). A number of the plurality of bits may be determined based on a range of the buffer sizes and the step size.

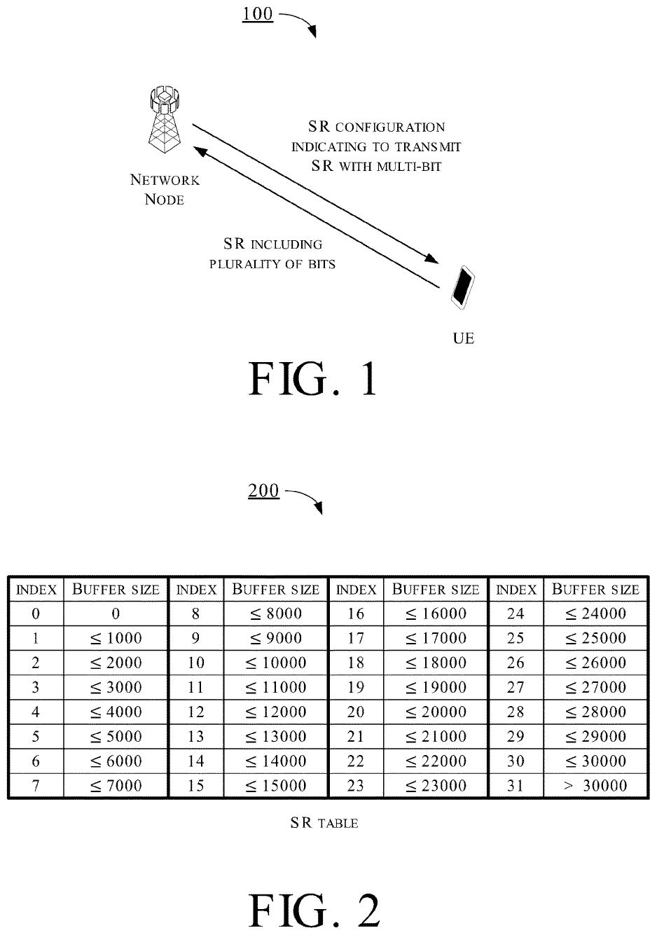

FIG. 2 illustrates an example scenario 200 under schemes in accordance with implementations of the present disclosure. For example, when the range of the buffer sizes needed to be reported is predetermined from 0 to 30000 and the step size is predetermined as 1000, there are 32 buffer state items in the SR table while: (1) the buffer state items are indexed from 0 to 31; and (2) the buffer state items include buffer sizes ranged from 0 to 30000 and increment with the same step size 1000. Therefore, the number of the plurality of bits included in the SR is determined to be 5 based on the range of the buffer sizes and the step size. In other words, the number of the plurality of bits included in the SR is determined to be 5 based on the number of the buffer state items.

More specifically, regarding the SR table, the corresponding index is selected as 0 if a pending data in the buffer of the UE has a size of 0, the corresponding index is selected as 1 if a pending data in the buffer of the UE has a size between 1 and 1000, the corresponding index is selected as 2 if a pending data in the buffer of the UE has a size between 1001 and 2000, and so on. In the last buffer state item, the corresponding index is selected as 31 if a pending data in the buffer of the UE has a size greater than 30000.

It should be noted that, it is not intended to limit the implementation of buffer state items. In other examples, the range of the buffer sizes needed to be reported may be predetermined from 0 to 31000 and in the last buffer state item, the corresponding index is selected as 31 if a pending data in the buffer of the UE has a size between 30000 and 31000. The buffer state items may be adjusted when necessary.

Accordingly, when a pending data in the buffer of the UE has a size of 10100, the UE selects index 11 and transmit the SR including 5 bits ‘01011’ to the network node. After receiving the SR including 5 bits ‘001011’, the network node obtains information of: (1) there is pending data needed to be transmitted from the UE; and (2) the size of the pending data is between 10000 to 11000. Therefore, the network node determines an UL grant and transmits the UL grant to the UE for data transmission.

It should be noted that, in some cases, the range of the buffer sizes (i.e., the minimum buffer size and the maximum buffer size) in the predefined SR Table may be configured according to typical packet sizes for specific applications or logical channels. In some cases, the range of the buffer sizes (i.e., the minimum buffer size and the maximum buffer size) and the step size are selected to ensure minimum quantization error.

Particularly, quantization error occurs when continuous variables are approximated by discrete values during the quantization process, leading to a difference between the actual value and its discrete representation. Continuous values are divided into intervals, each represented by a midpoint or average value. The actual value is mapped to the nearest representative value, and the error is the difference between the actual continuous value and the representative discrete value. When the step size between quantization intervals increases exponentially, the quantization error becomes significant in some scenarios. On the other hand, when the step size between quantization intervals is the same, the quantization error stays more stable. Accordingly, to ensure minimum quantization error when using the SR table, the step size between the buffer sizes being the same is one solution.

In some implementations, the network may transmit a first SR table and a second table to the UE. The first SR table may include a plurality of first buffer state items. The second SR table may include a plurality of second buffer state items. The plurality of bits may indicate the pending data and the size of the pending data based on at least one of the plurality of first buffer state items and the plurality of second buffer state items.

Specifically, the first SR table and the second SR table may be network side predefined tables and transmitted in a higher layer signaling (e.g., RRC configuration). In the first SR table, each of the plurality of first buffer state items may include a first index and a first buffer size. The first buffer sizes may increment with a same first step size (i.e., the first buffe sizes of the first buffer state items increase linearly). In the second SR table, each of the plurality of second buffer state items may include a second index and a second buffer size. The second buffer sizes may increment with a same second step size (i.e., the second buffe sizes of the second buffer state items increase linearly). A number of the plurality of bits may be determined based on one of: (1) a range of the first buffer sizes and the first step size; and (2) a range of the second buffer sizes and the second step size.

In some implementations, the number of the plurality of bits may be determined as ‘X’ based on the range of the first buffer sizes and the first step size, and the number of the plurality of bits may be determined as ‘Y’ based on the range of the second buffer sizes and the second step size. When the UE use the first SR table for the pending data and the size of the pending data, the UE may transmit the SR including ‘X’ bits to the network node. After receiving the SR including ‘X’ bits, the network node may refer to the first SR table according to ‘X’ bits and obtain information of the pending data and the size of the pending data based on the first SR table. Then, the network node may transmit an UL grant to the UE for data transmission. When the UE use the second SR table for the pending data and the size of the pending data, the UE may transmit the SR including ‘Y’ bits to the network node. After receiving the SR including ‘Y’ bits, the network node may refer to the second SR table according to ‘Y’ bits and obtain information of the pending data and the size of the pending data based on the second SR table. Then, the network node may transmit an UL grant to the UE for data transmission.

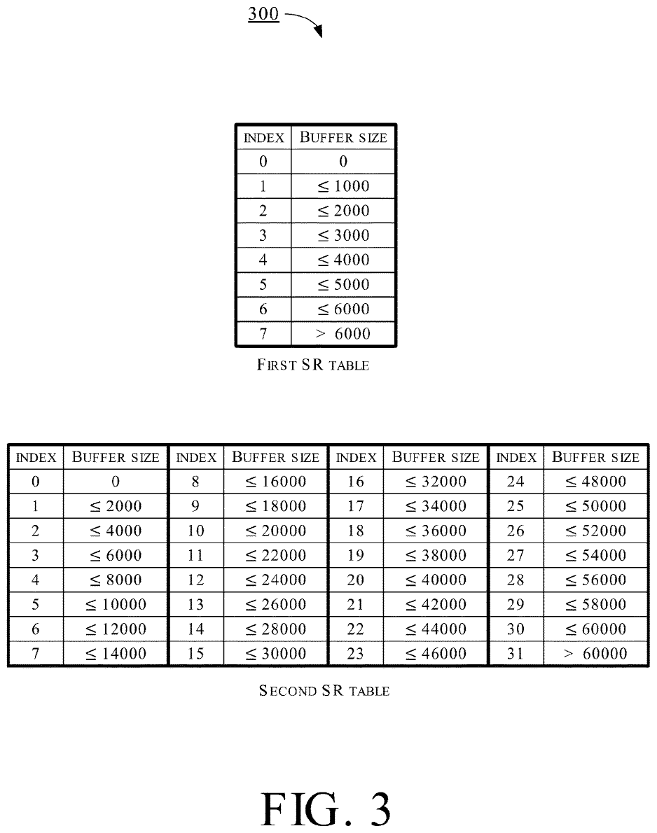

FIG. 3 illustrates an example scenario 300 under schemes in accordance with implementations of the present disclosure. For example, the first SR table is used for smaller buffer size range. When the range of the first buffer sizes needed to be reported is predetermined from 0 to 6000 and the first step size is predetermined as 1000, there are 8 first buffer state items in the first SR table while: (1) the first buffer state items are indexed from 0 to 7; and (2) the first buffer state items include first buffer sizes ranged from 0 to 6000 and increment with the same first step size 1000. Therefore, the number of the plurality of bits included in the SR is determined to be 3 based on the range of the first buffer sizes and the first step size. In other words, the number of the plurality of bits included in the SR is determined to be 3 based on the number of the first buffer state items.

The second SR table is used for bigger buffer size range. When the range of the second buffer sizes needed to be reported is predetermined from 0 to 60000 and the second step size is predetermined as 2000, there are 32 second buffer state items in the second SR table while: (1) the second buffer state items are indexed from 0 to 31; and (2) the second buffer state items include second buffer sizes ranged from 0 to 60000 and increment with the same second step size 2000. Therefore, the number of the plurality of bits included in the SR is determined to be 5 based on the range of the second buffer sizes and the second step size. In other words, the number of the plurality of bits included in the SR is determined to be 5 based on the number of the second buffer state items.

More specifically, regarding the first SR table, the corresponding index is selected as 0 if a pending data in the buffer of the UE has a size between 0 and 1000, the corresponding index is selected as 1 if a pending data in the buffer of the UE has a size between 1001 and 2000, the corresponding index is selected as 2 if a pending data in the buffer of the UE has a size between 2001 and 3000, and so on. In the last buffer state item, the corresponding index is selected as 7 if a pending data in the buffer of the UE has a size greater than 6000.

Regarding the second SR table, the corresponding index is selected as 0 if a pending data in the buffer of the UE has a size 0, the corresponding index is selected as 1 if a pending data in the buffer of the UE has a size between 1 and 2000, the corresponding index is selected as 2 if a pending data in the buffer of the UE has a size between 2001 and 4000, and so on. In the last buffer state item, the corresponding index is selected as 31 if a pending data in the buffer of the UE has a size greater than 60000.

It should be noted that, it is not intended to limit the implementations of the first buffer state items in the first SR table and the second buffer state item in the second SR table. The first buffer state items in the first SR table and the second state items in the second SR table may be adjusted when necessary.

In some scenarios, when the total buffer size to be reported by the UE can be indexed using the first SR table, the UE uses the first SR table. In some scenarios, when the total buffer size to be reported by the UE cannot be indexed using the first SR table, the UE uses the second SR table. In some scenarios, when the total buffer size to be reported can be indexed by both the first SR table and the second SR table, the UE uses the first SR table. In some scenarios, when the total buffer size to be reported can be indexed by both the first SR table and the second SR table, the UE uses the second SR table.

Accordingly, when a pending data in the buffer of the UE has a size of 4100, the UE selects index 5 of the first SR table and transmit the SR including 3 bits ‘101’ to the network node. After receiving the SR including 3 bits ‘101’, the network node obtains information of: (1) there is pending data needed to be transmitted from the UE; and (2) the size of the pending data is between 4000 to 5000. Therefore, the network node determines an UL grant and transmits the UL grant to the UE for data transmission.

Similarly, when a pending data in the buffer of the UE has a size of 17000, the UE selects index 9 of the second SR table and transmit the SR including 5 bits ‘01001’ to the network node. After receiving the SR including 5 bits ‘01001’, the network node obtains information of: (1) there is pending data needed to be transmitted from the UE; and (2) the size of the pending data is between 16000 to 18000. Therefore, the network node determines an UL grant and transmits the UL grant to the UE for data transmission.

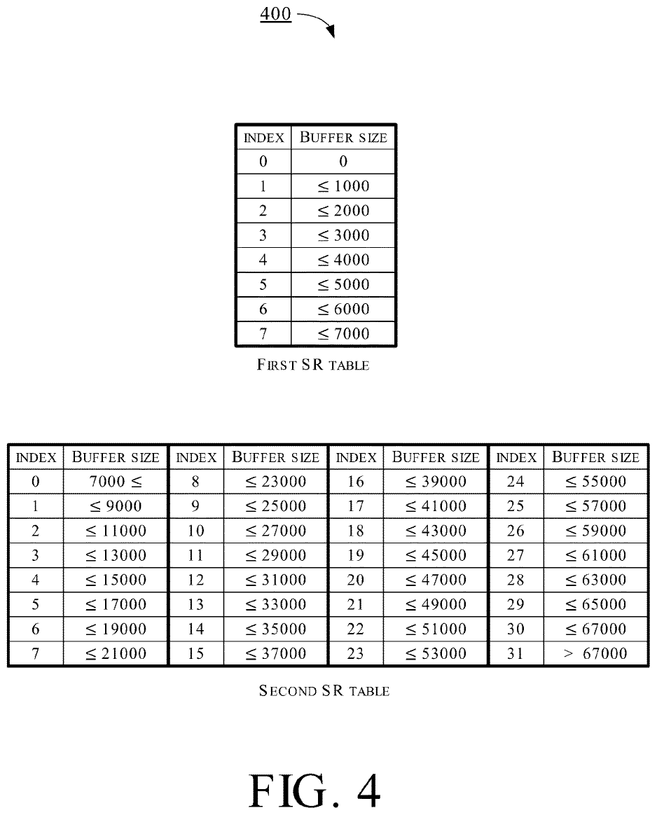

FIG. 4 illustrates an example scenario 400 under schemes in accordance with implementations of the present disclosure. For example, the first SR table is used for smaller buffer size range. When the range of the first buffer sizes needed to be reported is predetermined from 0 to 7000 and the first step size is predetermined as 1000, there are 8 first buffer state items in the first SR table while: (1) the first buffer state items are indexed from 0 to 7; and (2) the first buffer state items include first buffer sizes ranged from 0 to 7000 and increment with the same first step size 1000. Therefore, the number of the plurality of bits included in the SR is determined to be 3 based on the range of the first buffer sizes and the first step size. In other words, the number of the plurality of bits included in the SR is determined to be 3 based on the number of the first buffer state items.

The second SR table is used for bigger buffer size range. When the range of the second buffer sizes needed to be reported is predetermined from 7000 to 67000 and the second step size is predetermined as 2000, there are 32 second buffer state items in the second SR table while: (1) the second buffer state items are indexed from 0 to 31; and (2) the second buffer state items include second buffer sizes ranged from 7000 to 67000 and increment with the same second step size 2000. Therefore, the number of the plurality of bits included in the SR is determined to be 5 based on the range of the second buffer sizes and the second step size. In other words, the number of the plurality of bits included in the SR is determined to be 5 based on the number of the second buffer state items.

More specifically, regarding the first SR table, the corresponding index is selected as 0 if a pending data in the buffer of the UE has a size between 0 and 1000, the corresponding index is selected as 1 if a pending data in the buffer of the UE has a size between 1001 and 2000, the corresponding index is selected as 2 if a pending data in the buffer of the UE has a size between 2001 and 3000, and so on. In the last buffer state item, the corresponding index is selected as 7 if a pending data in the buffer of the UE has a size between 6001 and 7000.

Regarding the second SR table, the corresponding index is selected as 0 if a pending data in the buffer of the UE has a size greater than 7000, the corresponding index is selected as 1 if a pending data in the buffer of the UE has a size between 7001 and 9000, the corresponding index is selected as 2 if a pending data in the buffer of the UE has a size between 9001 and 11000, and so on. In the last buffer state item, the corresponding index is selected as 31 if a pending data in the buffer of the UE has a size greater than 67000.

It should be noted that, it is not intended to limit the implementations of the first buffer state items in the first SR table and the second buffer state item in the second SR table. The first buffer state items in the first SR table and the second state items in the second SR table may be adjusted when necessary.

Accordingly, when a pending data in the buffer of the UE has a size of 5050, the UE selects index 6 of the first SR table and transmit the SR including 3 bits ‘110’ to the network node. After receiving the SR including 3 bits ‘110’, the network node obtains information of: (1) there is pending data needed to be transmitted from the UE; and (2) the size of the pending data is between 5000 to 6000. Therefore, the network node determines an UL grant and transmits the UL grant to the UE for data transmission.

Similarly, when a pending data in the buffer of the UE has a size of 20000, the UE selects index 6 of the second SR table and transmit the SR including 5 bits ‘00111’ to the network node. After receiving the SR including 5 bits ‘00111’, the network node obtains information of: (1) there is pending data needed to be transmitted from the UE; and (2) the size of the pending data is between 19000 to 21000. Therefore, the network node determines an UL grant and transmits the UL grant to the UE for data transmission.

It should be noted that, in some cases, the range of the buffer sizes (i.e., the minimum buffer size and the maximum buffer size) in the predefined SR Tables may be configured according to typical packet sizes for specific applications or logical channels. In some cases, the range of the buffer sizes (i.e., the minimum buffer size and the maximum buffer size) and the step sizes may be selected to ensure minimum quantization error.

It should be noted that, regarding the above tables and buffer sizes, the unit of the buffer size may be “byte”. However, it is not intended to limit the implementation of the tables and the buffer sizes.

In some implementations, the network may transmit an SR table configuration to the UE. The SR table configuration may include a minimum buffer size, a maximum buffer size and a table size. After receiving the SR table configuration, the UE may determine an SR table including a plurality of buffer state items based on the minimum buffer size, the maximum buffer size and the table size.

Specifically, the table size may represent a maximum number of entries in the SR Table. In other words, the table size may be used to determine a number of the plurality of bits of the SR used to report indexes of the SR Table. The minimum buffer size may represent a minimum buffer size of the SR Table. The maximum buffer size may represent a maximum buffer size of the SR Table.

In some cases, the UE may determine a step size in the SR table as:

$$step size = \frac{( maximum buffer size ) - ( minmum buffer size )}{table size}$$

and the buffer size of the last buffer state item may be set as an upper bound.

In some cases, the UE may determine a step size in the SR table as:

$$step size = \frac{( maximum buffer size ) - ( minmum buffer size )}{table size - 1}$$

and the buffer size of the last buffer state item may be set as a specific number while the size of the pending data exceeds the specific number.

However, it is not intended to limit the implementation of determination of the step size. The determination of the step size may be adjusted when necessary.

### Illustrative Implementations

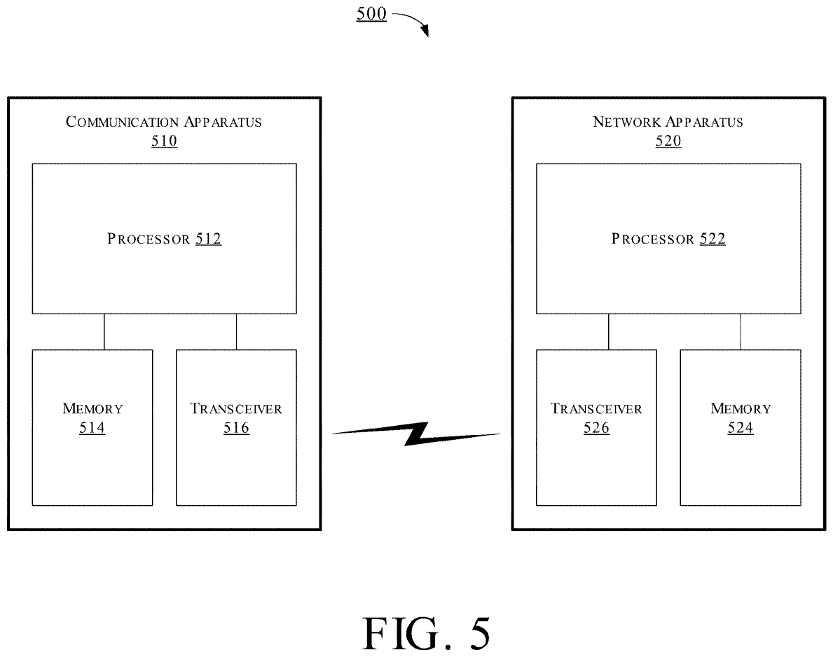

FIG. 5 illustrates an example communication system 500 having an example communication apparatus 510 and an example network apparatus 520 in accordance with an implementation of the present disclosure. Each of communication apparatus 510 and network apparatus 520 may perform various functions to implement schemes, techniques, processes and methods described herein pertaining to multi-bits SR transmission with respect to UE and network apparatus in mobile communications, including scenarios/schemes described above as well as processes 600 and 700 described below.

Communication apparatus 510 may be a part of an electronic apparatus, which may be a UE such as a portable or mobile apparatus, a wearable apparatus, a wireless communication apparatus or a computing apparatus. For instance, communication apparatus 510 may be implemented in a smartphone, a smartwatch, a personal digital assistant, a digital camera, or a computing equipment such as a tablet computer, a laptop computer or a notebook computer. Communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 510 may include at least some of those components shown in FIG. 5 such as a processor 512, for example. Communication apparatus 510 may further include one or more other components not pertinent to the proposed scheme of the present disclosure (e.g., internal power supply, display device and/or user interface device), and, thus, such component(s) of communication apparatus 510 are neither shown in FIG. 5 nor described below in the interest of simplicity and brevity.

Network apparatus 520 may be a part of a network apparatus, which may be a network node such as a satellite, a base station, a small cell, a router or a gateway. For instance, network apparatus 520 may be implemented in an eNodeB in an LTE network, in a gNB in a 5G/NR, IoT, NB-IoT or IIoT network or in a satellite or base station in a 6G network. Alternatively, network apparatus 520 may be implemented in the form of one or more IC chips such as, for example and without limitation, one or more single-core processors, one or more multi-core processors, or one or more RISC or CISC processors. Network apparatus 520 may include at least some of those components shown in FIG. 5 such as a processor 522, for example. Network apparatus 520 may further include one or more other components not pertinent to the proposed scheme of the present disclosure (e.g., internal power supply, display device and/or user interface device), and, thus, such component(s) of network apparatus 520 are neither shown in FIG. 5 nor described below in the interest of simplicity and brevity.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including multi-bits SR transmission in a device (e.g., as represented by communication apparatus 510) and a network (e.g., as represented by network apparatus 520) in accordance with various implementations of the present disclosure.

In some implementations, communication apparatus 510 may also include a transceiver 516 coupled to processor 512 and capable of wirelessly transmitting and receiving data. In other words, processor 512 may transceive the data such as configuration, message, signal, information, indicator, etc. via transceiver 516. In some implementations, communication apparatus 510 may further include a memory 514 coupled to processor 512 and capable of being accessed by processor 512 and storing data therein. In some implementations, network apparatus 520 may also include a transceiver 526 coupled to processor 522 and capable of wirelessly transmitting and receiving data. In other words, processor 522 may transceive the data such as configuration, message, signal, information, indicator, etc. via transceiver 526. In some implementations, network apparatus 520 may further include a memory 524 coupled to processor 522 and capable of being accessed by processor 522 and storing data therein. Accordingly, communication apparatus 510 and network apparatus 520 may wirelessly communicate with each other via transceiver 516 and transceiver 526, respectively. To aid better understanding, the following description of the operations, functionalities and capabilities of each of communication apparatus 510 and network apparatus 520 is provided in the context of a mobile communication environment in which communication apparatus 510 is implemented in or as a communication apparatus or a UE and network apparatus 520 is implemented in or as a network node of a communication network.

In some implementations, each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

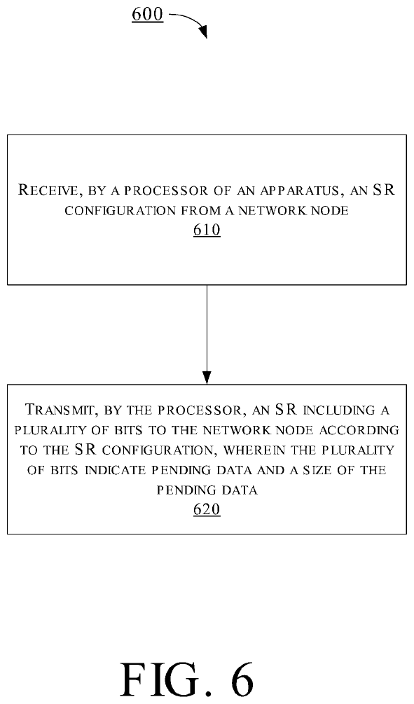

FIG. 6 illustrates an example process 600 in accordance with an implementation of the present disclosure. Process 600 may be an example implementation of above scenarios/schemes, whether partially or completely, with respect to multi-bits SR transmission of the present disclosure. Process 500 may represent an aspect of implementation of features of communication apparatus 510. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by communication apparatus 510 or any suitable UE or machine type devices. Solely for illustrative purposes and without limitation, process 600 is described below in the context of communication apparatus 510. Process 600 may begin at block 610.

At block 610, process 600 may involve processor 512 of communication apparatus 510 receiving an SR configuration from a network node. Process 600 may proceed from block 610 to block 620.

At block 620, process 600 may involve processor 512 of communication apparatus 510 transmitting an SR including a plurality of bits to the network node according to the SR configuration. The plurality of bits may indicate pending data and a size of the pending data.

In some implementations, process 600 may involve processor 512 of communication apparatus 510 receiving an SR table from the network node. The SR table may include a plurality of buffer state items. The plurality of bits may indicate the size of the pending data based on at least one of the plurality of buffer state items.

In some implementations, each of the plurality of buffer state items may include an index and a buffer size, and the buffer sizes may increment with a same step size.

In some implementations, a number of the plurality of bits may be determined based on a range of the buffer sizes and the step size.

In some implementations, process 600 may involve processor 512 of communication apparatus 510 receiving a first SR table and a second SR table from the network node. The first SR table may include a plurality of first buffer state items and the second SR table includes a plurality of second buffer state items. The plurality of bits may indicate the size of the pending data based on at least one of the plurality of first buffer state items and the plurality of second buffer state items.

In some implementations, each of the plurality of first buffer state items may include a first index and a first buffer size, each of the plurality of second buffer state items may include a second index and a second buffer size, the first buffer sizes may increment with a same first step size, and the second buffer sizes may increment with a same second step size.

In some implementations, a number of the plurality of bits may be determined based on a range of the first buffer sizes and the first step size or determined based on a range of the second buffer sizes and the second step size.

In some implementations, process 600 may involve processor 512 of communication apparatus 510 receiving an SR table configuration from the network node, wherein the SR table configuration includes a minimum buffer size, a maximum buffer size and a table size. Process 600 may involve processor 512 of communication apparatus 510 determining an SR table including a plurality of buffer state items based on the minimum buffer size, the maximum buffer size and the table size.

In some implementations, the SR including the plurality of bits may be for a latency critical application.

In some implementations, the pending data is associated with at least one logical channel.

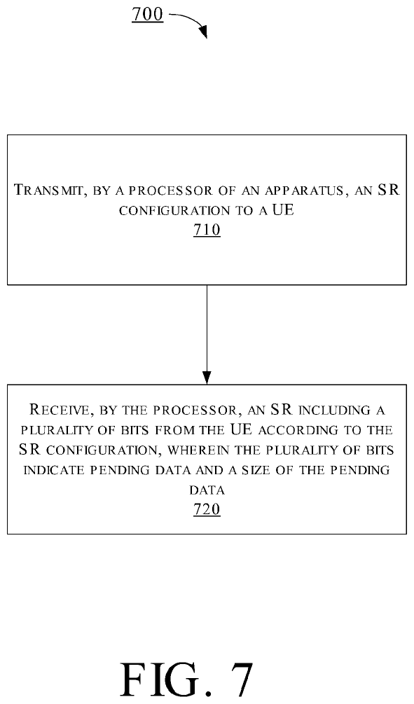

FIG. 7 illustrates an example process 700 in accordance with an implementation of the present disclosure. Process 700 may be an example implementation of above scenarios/schemes, whether partially or completely, with respect to multi-bits SR transmission of the present disclosure. Process 700 may represent an aspect of implementation of features of network apparatus 520. Process 700 may include one or more operations, actions, or functions as illustrated by one or more of blocks 710 to 720. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by network apparatus 520 or any suitable network device or machine type devices. Solely for illustrative purposes and without limitation, process 700 is described below in the context of network apparatus 520. Process 700 may begin at block 710.

At block 710, process 700 may involve processor 522 of network apparatus 520 transmitting an SR configuration to a UE. Process 700 may proceed from block 710 to block 720.

At block 720, process 700 may involve processor 522 of network apparatus 520 receiving an SR including a plurality of bits from the UE according to the SR configuration. The plurality of bits may indicate pending data and a size of the pending data.

In some implementations, process 700 may involve processor 522 of network apparatus 520 transmitting an SR table to the UE. The SR table may include a plurality of buffer state items. The plurality of bits may indicate the size of the pending data based on at least one of the plurality of buffer state items.

In some implementations, each of the plurality of buffer state items may include an index and a buffer size, and the buffer sizes may increment with a same step size.

In some implementations, a number of the plurality of bits may be determined based on a range of the buffer sizes and the step size.

In some implementations, process 700 may involve processor 522 of network apparatus 520 transmitting a first SR table and a second SR table to the UE, wherein the first SR table includes a plurality of first buffer state items and the second SR table includes a plurality of second buffer state items. The plurality of bits may indicate the size of the pending data based on at least one of the plurality of first buffer state items and the plurality of second buffer state items.

In some implementations, each of the plurality of first buffer state items may include a first index and a first buffer size, each of the plurality of second buffer state items may include a second index and a second buffer size, the first buffer sizes may increment with a same first step size, and the second buffer sizes may increment with a same second step size.

In some implementations, a number of the plurality of bits may be determined based on a range of the first buffer sizes and the first step size or determined based on a range of the second buffer sizes and the second step size.

In some implementations, process 700 may involve processor 522 of network apparatus 520 transmitting an SR table configuration to the UE. The SR table configuration may include a minimum buffer size, a maximum buffer size and a table size for determining an SR table including a plurality of buffer state items. The plurality of bits may indicate the size of the pending data based on at least one of the plurality of buffer state items.

In some implementations, the pending data is associated with at least one logical channel.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a scheduling request (SR) configuration from a network node; and
transmitting, by the processor, an SR including a plurality of bits to the network node according to the SR configuration, wherein the plurality of bits indicates pending data and a size of the pending data.

2. The method of claim 1, further comprising:
receiving, by the processor, an SR table from the network node, wherein the SR table includes a plurality of buffer state items;
wherein the plurality of bits indicates the size of the pending data based on at least one of the plurality of buffer state items.

3. The method of claim 2, wherein each of the plurality of buffer state items includes an index and a buffer size, and the buffer sizes increment with a same step size.

4. The method of claim 3, wherein a number of the plurality of bits is determined based on a range of the buffer sizes and the step size.

5. The method of claim 1, further comprising:
receiving, by the processor, a first SR table and a second SR table from the network node, wherein the first SR table includes a plurality of first buffer state items and the second SR table includes a plurality of second buffer state items;
wherein the plurality of bits indicates the size of the pending data based on at least one of the plurality of first buffer state items and the plurality of second buffer state items.

6. The method of claim 5, wherein each of the plurality of first buffer state items includes a first index and a first buffer size, each of the plurality of second buffer state items includes a second index and a second buffer size, the first buffer sizes increment with a same first step size, and the second buffer sizes increment with a same second step size.

7. The method of claim 6, a number of the plurality of bits is determined based on a range of the first buffer sizes and the first step size or determined based on a range of the second buffer sizes and the second step size.

8. The method of claim 1, further comprising:
receiving, by the processor, an SR table configuration from the network node, wherein the SR table configuration includes a minimum buffer size, a maximum buffer size and a table size;
determining, by the processor, an SR table including a plurality of buffer state items based on the minimum buffer size, the maximum buffer size and the table size.

9. The method of claim 1, wherein the SR including the plurality of bits is for a latency critical application.

10. The method of claim 1, wherein the pending data is associated with at least one logical channel.

11. A method, comprising:
transmitting, by a processor of an apparatus, a scheduling request (SR) configuration to a user equipment (UE); and
receiving, by the processor, an SR including a plurality of bits from the UE according to the SR configuration, wherein the plurality of bits indicates pending data and a size of the pending data.

12. The method of claim 11, further comprising:
transmitting, by the processor, an SR table to the UE, wherein the SR table includes a plurality of buffer state items;
wherein the plurality of bits indicates the size of the pending data based on at least one of the plurality of buffer state items.

13. The method of claim 12, wherein each of the plurality of buffer state items includes an index and a buffer size, and the buffer sizes increment with a same step size.

14. The method of claim 13, wherein a number of the plurality of bits is determined based on a range of the buffer sizes and the step size.

15. The method of claim 11, further comprising:
transmitting, by the processor, a first SR table and a second SR table to the UE, wherein the first SR table includes a plurality of first buffer state items and the second SR table includes a plurality of second buffer state items;
wherein the plurality of bits indicates the size of the pending data based on at least one of the plurality of first buffer state items and the plurality of second buffer state items.

16. The method of claim 15, wherein each of the plurality of first buffer state items includes a first index and a first buffer size, each of the plurality of second buffer state items includes a second index and a second buffer size, the first buffer sizes increment with a same first step size, and the second buffer sizes increment with a same second step size.

17. The method of claim 16, a number of the plurality of bits is determined based on a range of the first buffer sizes and the first step size or determined based on a range of the second buffer sizes and the second step size.

18. The method of claim 11, further comprising:
transmitting, by the processor, an SR table configuration to the UE, wherein the SR table configuration includes a minimum buffer size, a maximum buffer size and a table size for determining an SR table including a plurality of buffer state items;
wherein the plurality of bits indicates the size of the pending data based on at least one of the plurality of buffer state items.

19. The method of claim 11, wherein the pending data is associated with at least one logical channel.

20. An apparatus, comprising:
a transceiver which, during operation, wirelessly communicates with a wireless network; and
a processor communicatively coupled to the transceiver such that, during operation, the processor performs operations comprising:
receiving, via the transceiver, a scheduling request (SR) configuration from a network node; and
transmitting, via the transceiver, an SR including a plurality of bits to the network node according to the SR configuration, wherein the plurality of bits indicates pending data and a size of the pending data.
